(19) United States
(12) Patent Application Publication
(10) Pub. No.: US 2022/0355961 A1
(43) Pub. Date: Nov. 10, 2022

(54) DEVICE FOR EXTENDING A FILM AND FOR WELDING THE FILM TO A CONNECTION PART HAVING AN AXIAL DIRECTION, AND METHOD, PRODUCTION METHOD, SYSTEM, AND BAG

(71) Applicant: KIEFEL GmbH, Freilassing (DE)

(72) Inventors: Rupert Gschwendtner, Bad Reichenhall (DE); Martin Klein, Hallein (AT)

(21) Appl. No.: 17/870,643

(22) Filed: Jul. 21, 2022

Related U.S. Application Data
(62) Division of application No. 16/326,984, filed on Feb. 21, 2019.

(30) Foreign Application Priority Data
Aug. 26, 2016 (DE) 10 2016 010 247.0
Apr. 20, 2017 (DE) 10 2017 003 802.3
Jul. 20, 2017 (DE) 10 2017 006 886.0

(51) Int. Cl. B65B 39/08; B29C 65/00; A61J 1/10; A61J 1/14; B29C 65/02; B65B 3/00; B65B 43/02; B65D 75/58; B65B 51/14; B65B 43/54; B65B 43/30; B65B 43/46; B29C 65/18; B29C 65/74

(52) U.S. Cl. CPC B65B 39/08; B29C 66/1122; A61J 1/10; A61J 1/1475; B29C 65/02; B29C 66/53262; B29C 66/814; B29C 66/849; B65B 3/003; B65B 43/02; B65D 75/5883; B29C 66/53263; B29C 66/343; B29C 66/0222; B65B 51/146; B65B 43/54; B65B 43/30; B65B 43/465; B29C 65/18; B29C 65/74; B29C 66/006; B29C 66/43121; B29C 66/8511; B29L 2031/7148

(57) ABSTRACT

The invention relates to a device for welding a connection region of a film to a connection part having an axial direction. In the case of conventional devices, there is the risk of steep workpiece edges causing uncontrolled weak spots in the film and in the weld seam. According to the invention, the film is extended in a controlled manner such that the film has a length reserve. The film is extended in such a way that the film has a deformation cross-section that runs out such that the deformation is not visible on the final product. In this connection, the invention further relates to a use of a film, to a method for welding, to a method for producing bags, to a system for producing bags, and to a bag.

### RELATED APPLICATION

The present invention is a Divisional Application claiming priority to U.S. National Phase application Ser. No. 16/326,984, filed on Feb. 21, 2019, which claims priority to PCT/DE2017/000216 filed on Jul. 21, 2017; the entireties of both are hereby incorporated herein by reference

The invention relates to a device for extending a film and for welding the film comprising an axial direction connecting part and a method, a manufacturing process, a plant and a bag.

In particular, the invention relates to a device for extending a film and for welding the film with an axial direction comprising connecting part, with an extension device for extending the film inside and/or outside a connection region of the film, wherein the extension device comprises a deformation tool, and a method of welding a connection region of a film with an axial direction comprising connecting part, a manufacturing method for bags for medical use by welding of two films with an axial direction comprising connecting part to a bag, a plant for producing bags, especially medical bags, of two foils with one between the films welded, an axial direction comprising connecting part and a bag made of two foils and one an axis direction comprising connecting part.

It is regularly the task, to weld a film or more films with a connecting part in a commercial production plant.

A very common example shows the WO 2007/140 760 A2. There bags are made, which are finally used as medical devices. For making the required connecting part on the bag a tubular connecting part is welded between two foils. For this purpose, the tubular connecting part is arranged to a Mandrene (german: Mandrene), usually referred to as central electrode. The films are even arranged above and below the connecting part. Then a tool moves to the foils, put them by further moving together of an upper and lower tool flat in a connection area around the connecting part until the foils dock together next to the connection region. Then, on the one hand a welded connection between the connection part and the foils, and on the other hand outside the connection region between the films is directly produced.

The WO 2010/025699 A1 discloses a device for welding a connection region of a film with a connecting part, in particular two films with a tubular connecting part, wherein in a first step an extension of the film is caused in controlled manner outside of the connection region, so that the film has a length reserve, which in the second step counteracts by the welding uncontrolled weakening of the film in the region of the connecting part.

In practice, two or more mandrenes are often arranged side by sides in a single welding operation. In this case, there are several connection regions, namely between the films and the individual tubular connecting parts, while between the connecting regions the films are directly welded together for sealing the produced bag.

It is understood that more than just two films can be used.

The invention is based on the object, to provide to the prior art an improvement or an alternative.

According to a first aspect of the invention, the object is solved by a device for extending a film and for welding the film having an axial direction comprising connecting part, for forming a bag for medical purposes, with an extension device for extending the film inside and/or outside a connecting region of the film, wherein the extension device comprises a deformation tool with an extension direction and with a deformation cross section, wherein the deformation tool comprises an area with an deformation cross-section running out in the direction of extension.

Conceptually, the following is explained:

First of all, it should be noted that within the scope of the present patent application indefinite articles and numbers such as “one”, “two” etc. normally should be understood as “at least” information, so as “at least a . . . ”,“at least two . . . ” etc., unless it is explicitly stated in the respective context or is obvious or technically compelling to the person skilled in the art, that there can only be meant “exactly one . . . ”, “exactly two . . . ” and so on.

As a “lengthening” of the film is a mechanical intervention in the molecular structure understood, which should provides the film with a length reserve, so that the two-dimensional film can require additional length during forming the three-dimensional connecting part without significant tensile forces from the extended region, and thus in any case itself not completely from the connection region. Normally, the lengthening would deflect the film out of his plane.

A “film” refers in particular to a thin plastic sheet, either as a single sheet or as an endless belt.

Under “welding” it is understood in particular the permanent connection of components under application of heat and/or pressure with or without additional welding materials.

A “connecting part” refers to a component that is welded to a foil. In particular, an often used connecting part is a plastic tube or a plastic body. By using a plastic tube, which has naturally at least “one axial direction”, for example, a bag with a tubular opening can be made.

An “extension device” is a device that is suitable and arranged to extend a film at least in one area of the film.

As “connection region” is to understand that area in which the film is to be connected with the connecting part and is connected after the connection.

Therefore, “outside the connection region” is to be understood as meaning an area of the film which should not be welded or brought into contact with the connecting part, but should lie laterally next to a connecting part, respectively in case of several connecting parts laterally between or next to the connection regions.

Accordingly, “within the connection area” is to be understood as an area which should have contact with the connecting part in the welded state.

A “deformation tool” refers to a tool that is suitable to reshape a film, in particular for extending a film in at least one area of the film.

An “extension direction” is the direction in which something extends. Here an extension direction means in particular a direction in which the deformation tool extends, wherein the extension direction means that direction, in the deformation tool has only slight changes in the contour. In particular, the extension direction may coincide with the axial direction of the connecting part, and/or the direction of extent may lie normal to a machine direction. In particular, the extension direction may be that direction in which a deformation cross section of the deformation tool is running out.

The “deformation cross-section” is to understand the contour of the deformation tool in the extension direction of the deformation tool. The contour is shown in the cross section of the deformation tool at right angles to the extension direction.

An “outgoing deformation cross section” is a deformation cross section of a deformation tool, whose contour changes in the extension direction so that the degree the deformation of the deformation tool runs out, preferably so far that the deformation cross-section of the deformation tool merges into a plane.

The prior art provides that a film is extended before welding to a connecting part. Thus, WO 2010/025699 A1 suggests to extend a film by means of a mechanical engagement, so that an additional length is available for the film in the area of the connection with the connecting part, so that the original two dimensional film can take his needed length when forming the three-dimensional connecting part without significant tensile forces from the extended area. The WO 2010/025699 A1 discloses that the deformation tool has a constant contour in its extending direction.

Deviating it is proposed here that the deformation tool has an expiring deformation cross-section in its extension direction, i.e. allows a gentle transition between the originally in any place flat foil and the deformed foil in the connecting area. The extension direction on the deformation tool is preferably that direction in which in the operation of the device, that is the machine or the station, the bags to be produced are extended.

Thus, the film can be extended in a controlled manner, whereby the film has a predominantly same length reserve in the connection region, which is leaking at the connection region ideally seamless and soft into a flat film.

The film can be suitable be deformed both directly inside and outside the connection region to obtain the necessary length reserve.

With a suitable design, the outgoing deformation cross-section of the deformation tool is designed such that the length reserve of the film is constant in the connection area, as already included in the prior art, and from there leaking so in the flat film that the deformation of the film on the final product is no longer visible.

Thus, in a particularly advantageous embodiment, it is conceivable that a bag can be made of two films and a filling tube, which consists of two in the connection region deformed films and a filling tube as a connecting part, wherein the deformation of the film is determined by the leakage in the extension direction of the deformation tool by the contouring of the deformation tool so that the films can be laid and welded from two sides without wrinkles and without further plastic deformation around the filling tube, wherein the deformation being such that it has no recognizable structures on the end product, i.e. the bag.

Thus, in concrete terms, in a particularly advantageous embodiment, it is conceivable that the film is so merged with the deformation tool that it is simultaneously deformed with the in the extension direction constant area of the deformation cross-section and in extension direction expiring region of the deformation cross-section.

As a variant, a particularly advantageous embodiment is concretely conceivable in which the film is merged with the deformation tool so that it is simultaneously deformed with a partial region of the region of the deformation cross-section which is constant in the direction of extent and the in the direction of extend extending area of the deformation cross-section.

As a further variant, a particularly advantageous embodiment is concretely conceivable, in which the film is so merged with the deformation tool that it is deformed only with the area of the deformation cross-section which extends in the extension direction or which is deformed only with a portion of the in the direction of the extend extending region of the deformation cross section is.

The device for extending the film and for welding the film with the an axial direction having connecting part can be designed advantageously in such a way that the film is lengthened and welded within a device.

The connecting part may have a tubular shape, a cylindrical shape, an angular shape or different shape. The deformation tool can be advantageously adapted so that the film depending on the shape of the connection part is reshaped and lengthened so that it can be unwound without any further plastic deformation from the connection part.

Advantageously, by the presented aspect of the invention it can be achieved that the film is first deformed in controlled manner in the connecting region, creating a length reserve, which allows to unwind part the film from the connection in the connecting region area without further plastic stretching, wherein the deformation is running out by the contouring of the deformation tool so it leaves on the final product no recognizable traces of deformation, thus increasing the value of such product.

Furthermore, it can be advantageously achieved that the welding quality can be improved by the pre-deformation of the film in terms of tightness of the weld and in terms of an avoiding a film shortening.

Advantageously, it can also be achieved that the film is deformed almost homogeneously, whereby larger variations in thickness in the film can be avoided.

By the running out in deformation cross section of the deformation tool it can also be advantageously achieved that almost no residual stresses in the deformed film remains, whereby the product properties can be also improved.

Preferably, the extension device is arranged in a tool pass, so that it can cause the extending of the film in time before welding.

Conceptually, the following is explained:

A “tool pass” denotes a passage of at least one semifinished product by a plurality of tools in a plant for producing a product or intermediate product, thus the passage through several stations. In particular, here is to understand under a tool pass the order in which a film passes through a plurality of tools. So the foil can pass in a tool pass first through an extension device, in which the film is lengthened at least in one area of the film before being subsequently welded using a welding tool with a connecting part.

In such a design, the extension device initially performs the lengthening of the film outside the designated extension area. Only then the film is placed with its connection region around the connecting part, i.e. for example, from the welding tool with the tool edges squeezed around the connecting part. The film pulls around the connecting part during the process of laying around the previously extended area from the side of the connection region.

Doing so, it can advantageously be achieved that an efficient production process can be realized with a high production speed and low production costs.

Furthermore, it may be advantageous that the area of the extended film can be cooled slightly after extending before it is welded to the connecting part, whereby the robustness of the process can also be improved so that less reject goods are produced.

Optionally, the deformation tool is configured to be in an area of the deformation tool to create a waveform in the film.

Conceptually, the following is explained:

A “waveform” is a possible shape of a contour of a deformation cross-section. In particular, a waveform may be periodic or aperiodic. Here is under a waveform both a harmonic and a disharmonic course to understand.

A waveform has the effect that the foil is formed out at least at one side out of its original plane is formed out, due to softer transitions and no kink or just a few kinks occur. Besides, waveforms can be defined relatively easy in their length, in the number of waves or in the amplitude and the corresponding tool.

A waveform can also have a zig-zag gradient as defined above a trapezoidal deflection from the film plane or a rectangular deflection from the film level.

Advantageously, this can be achieved that comparatively as well as on the geometry based simple deformation tools can be manufactured and used.

Furthermore, it is advantageous that the deformation tool can be adjusted optimally to the contour of the connecting part, so that a high welding quality in terms of tightness of the weld can result.

Preferably, the deformation tool is adapted to create the waveform with a sinusoidal shape.

Conceptually, the following is explained:

A “sinusoidal shape” is to understand as a sinusoidal shape of a contour of a deformation cross-section.

Thus, the deformation tool may be adapted to produce the waveform in the film in a sinusoidal shape in section.

Advantageously, doing so, it can be achieved that the deformation of the film can take a harmonic contour, whereby a particularly desirable film thickness profile of the deformed film can result, in particular with a constant film thickness in the area of deformation and/or with only a little possible variations in thickness.

Optionally, the deformation tool is set up to create a symmetrical deformation cross-section.

Conceptually, the following is explained:

A “symmetrical deformation cross section” is to be understood as a deformation cross section, which comprises an axis of symmetry in at least one plane of the deformation in which its direction of their normal vector coincides with the extension direction of the deformation tool.

Advantageously, doing so, it can be achieved that the symmetrical design of the deformation cross-section is ideally corresponding with a symmetrically designed connecting part. This can lead to an ideal weld pattern with high weld quality.

Preferably, the deformation tool is adapted to create an asymmetric deformation cross-section.

Conceptually, the following is explained:

An “asymmetric deformation cross-section” is considered to be a deformation cross-section which comprises no axis of symmetry in at least one plane of the deformation by which its direction of their normal vector coincides with the extension direction of the deformation tool.

It is concretely conceivable, inter alia, that an asymmetrical design of the deformation cross-section is reached.

Advantageously, this can be achieved that the asymmetrical design of the deformation cross-section corresponds ideally with a correspondingly asymmetrically designed connecting part. This can lead to an ideal weld pattern with high weld quality.

In a particularly advantageous embodiment, it is conceivable, inter alia, that an asymmetric deformation is characterized in that the first film and the second film have deviating deformation cross-sections and/or are deformed with different deforming tools with deviating deformation cross sections.

In a particularly preferred embodiment, the first film and the second film comprises a different material. So it is conceivable, among other things that the first film has a plastic-coated aluminum and the second film has a polyethylene so that the first film and the second film have a different material characteristic, in particular a different stretching characteristic. With deviating forming cross-sections, the deviating material behaviour can be used so that an adapted ideal deformation cross-section can be achieved, which can lead in particular to an optimal result when welding with the connecting part.

A particularly preferred embodiment also results for a connecting part, which is not designed symmetrically to the separation plane of the bag. So it can be reached with the here presented aspect of the invention that the pre-deformation is so adapted to the shape of the insertion part so that it can be achieved an adapted ideal deformation cross-section which, in particular, leads to an optimal result in welding with the connector can lead.

Advantageously, it can be achieved by the here presented aspect of the invention that the deformation cross-section can be so adjusted so that a different material characteristic between the first and second foil and/or an asymmetrical design of a connecting part can de compensated by a different deformation cross-section and an optimized welding result can be achieved in the area of the connection part.

Optionally, the deformation tool is adapted in an area of the deformation tool to create a length reserve in the film, which is dimensioned between two fixed points of the film at least as a half winding of the connection region, especially the complete winding of the connection region.

Conceptually, the following is explained:

A “length reserve” is referred, in an extended area of a film, as the additional created length compared to the previous condition due to the effect of the extension. Since an extension is related often only in one area of a film a length reserve arises compared to the adjacent area.

A “Winding” of a surface is considered to be the extension of an area in a plane so that the measured length on the original surface is maintained.

Thus, the length reserve achieved by lengthening the film can be designed in such a way that it can be placed or guided directly around the connecting part, in particular without further plastic stretching of the film.

Advantageously, can be achieved by the here presented aspect of the invention that the film is first deformed controlled in the connection region, creating a length reserve, which allows to unwind the film in the connection region without further plastic strain the connecting part, wherein the deformation runs out by the contouring of the deformation tool so that it leaves on the final product no recognizable traces of deformation, thus increasing the value of such product.

Furthermore, it can be advantageously achieved that the welding quality can be improved by the pre-deformation of the film in terms of tightness of the weld and in terms of avoiding a film shortening.

Advantageously, it can also be achieved that the film is deformed almost homogeneously, whereby larger variations in thickness in the film can be avoided.

The extension device preferably has a film heater.

Conceptually, the following is explained:

A “film heater” is a device for heating a film, in particular an element for transferring heat energy to a film.

Thus, the extension device and/or the film can be tempered directly continuous or discontinuous by a film heater.

Advantageously, doing so, it can be achieved that the film is tempered in the area of extension to be generated, so that the film can flow better and can be extended with a lower mechanical pressure.

Furthermore, it can be result advantageously that the film can be deformed homogeneously, can have lower thickness variations and that the film can have a constant thickness as possible also in the deformation range after deformation.

Furthermore, it can be advantageously achieved that the welding quality can be improved by the pre-deformation of the film in terms of tightness of the weld and in terms of avoiding a film shortening.

Optionally, the extension device has a heated deformation tool.

Conceptually, the following is explained:

A “heated deformation tool” is to be understood as a deformation tool which has a heating element and is supplied with energy from the outside.

Thus, the deformation tool can be continuous or discontinuous tempered by a heating element in the interior or on one side of the deformation tool.

Advantageously, doing so, it can be achieved that the film is tempered in the area of extension to be generated by the contact with the deformation tool and by the from deformation tool outgoing heat radiation, so that the film can flow better and can be extended with a lower mechanical pressure.

Advantageously, doing so, results that the film can be deformed more homogeneous, can have lower thickness variations and that the film can have a constant thickness as possible also in the deformation range after deformation.

Furthermore, it can be advantageously achieved that the welding quality can be improved by the pre-deformation of the film in terms of tightness of the weld and in terms of avoiding a film shortening.

The extension device preferably has a radiation heater.

Conceptually, the following is explained:

A “radiation heater” uses in particular heat radiation for heating a component, in particular a film. In particular, this is understood to mean a radiation heater as a heat radiator whose radiation reaches at least a portion of the film in the extension device.

Thus, the and/or the film can directly or continuously be tempered by a discontinuous radiation heating.

Advantageously, doing so, it can be achieved that the film is tempered in the area of extension being generated by the contact with the deformation tool and from the deformation tool outgoing heat radiation and/or by the outgoing radiation heating, so that the film can flow better and can be extended and with a lower mechanical pressure.

Advantageously, doing so, it results that the film can be deformed homogeneous, it may have lower thickness variations, and the film can have also in the deformation range after deformation a constant thickness as possible.

Furthermore, it can be advantageously achieved that the welding quality can be improved by the pre-deformation of the film in terms of tightness of the weld and in terms of an avoiding a film shortening.

Optionally, the device has a transport device for an endless film belt and/or a turntable.

Conceptually, the following is explained:

A “transport device” is a device for transporting a film between two points or for continuous or discontinuous transport of an endless foil belt.

An “endless film belt” is a film belt with a length that is significantly larger than the width of the film belt, in particular, the length of the film belt is at least five times as long as the width of the foil belt.

A “turntable” is a table that is able to perform a rotary motion.

Thus, in a suitable embodiment of the invention, an endless film belt is transported and processed through the device.

A turntable can be used to reduce the required installation space for the device and/or the number of necessary supplied endless film belts.

Doing so, it can advantageously be achieved, that an efficient production process with a high production speed and low production costs can be realized.

Preferably, the extension device and a welding device are arranged at a station.

Conceptually, the following is explained:

A “welding device” is a device which is used to weld a film, in particular for welding a film with a connecting part.

A “station” is a spatially related area of a plant, in particular a plant, in particular of a plant having a plurality of stations. At a station several operations are performed, in particular without further transporting the film between the operation steps.

Thus, doing so, the arrangement of the extension device can be performed to an already existing welding device at a station.

Advantageously, thereby it can be achieved that a spatially more compact plant can be realized, wherein also the throughput times through the system can be reduced.

Optionally, the extension device and the welding device are arranged at a combined tool.

Conceptually, the following is explained:

A “combined tool” is to be understood as a tool with which several steps can be performed combined, in particular, the operation steps be carried out one behind the other.

Advantageously, doing so, it can be achieved that both steps can be performed with a tool, so that the system can build more compact, the changeover times can be reduced and a more efficient production process and low production costs can be realized with a high production speed.

Alternatively, the extension device and the welding device are arranged on separate stations.

Advantageously, doing so, it can be achieved that the processing times can be reduced through the plant, so that more products can be produced at the same time and production costs can be lowered.

Optionally, the extension means is so arranged that it causes a prolongation of the length of the film between two connection regions.

Thus, for example, in an advantageous embodiment of this invention it is conceivable that a film is welded with two connecting parts and the required length reserve of the film is realized by extending the film between the two connecting portions.

Doing so, it can be advantageously achieved that a more efficient production process with a high production speed and low production costs can be realized.

According to a second aspect of the invention, the object is solved by a method for welding a connection region of a film having an axial direction comprising connecting part with a device according to the first aspect of the invention, wherein the film is first extended and then the connection region is welded with an axial direction having connecting part.

It is understood that the advantages of a device for extending a film and for welding the foil with an axial direction having connecting part, with an extension device for extending the film inside and/or outside a connection region of the film, wherein the extension device comprises a deformation tool, wherein the deformation tool comprises in an extension direction of the deformation tool a region with an in extension direction running out area with a cross section of the deformation tool, as described above is applied immediately to a method for welding a connection region of a film having an axial direction comprising connecting part with just this device, wherein the film is first extended and then the connection region is welded with an axial direction having connecting part.

It should be expressly understood that the subject of the second aspect can be advantageously combined with the object of the first aspect of the invention.

According to a third aspect of the invention, the object is solved by a manufacturing method for bags for use for medical purposes by welding two films with one an axial direction having connecting part to a bag, wherein the one an axial direction having connecting part is welded in a connection region between the films, wherein the method is being characterized by the following steps:

(a) forming a first foil with a forming tool inside and/or outside the connection region, in particular with a device according to the first aspect of the invention, wherein the deformation tool comprises a first deformation cross-section,

(b) deforming a second film with a deformation tool inside and/or outside the connection region, in particular with a device according to the first aspect of the invention, wherein the deformation tool comprises a second deformation cross-section, wherein the second deformation cross-section deviates from the first deformation cross section, and

(c) welding the first film, the second film and the one axial direction having connector part to a bag.

The prior art has until now provided that those films used to weld a bag were not pre-formed or deformed immediately with the welding tool or pre-formed with a to a bag separation plane symmetrical deformation cross-section.

In contrast, it is proposed here that those films used for welding a bag with a deformation cross section which is asymmetrically to the separation plane bag were pre-formed. In other words, it is suggested that the films are deformed with a deformation cross-section different from each other.

It is concretely conceivable, among other things, that the first film and the second film have different deformation cross-sections and/or are deformed with different deformation tools, which have different deformation cross-sections.

In a particularly preferred embodiment, the first film and the second film comprise a different material. So it is conceivable, among other things, that the first film has a plastic-coated aluminum and the second film has a polyethylene, so that the first film and the second film have different material characteristics, in particular a different stretching characteristic. With different deformation cross sections the different material characteristic can be made so usable that an adapted ideal deformation cross-section can be achieved, which leads is in particular to an optimal result when welding to the connecting part.

A particularly preferred embodiment also results for a connecting part, which is not designed symmetrically to the separation plane of the bag. So can it can be achieved with the here presented aspect of the invention that the pre-deformation of the shape is adapted so to the insert part, that is can be achieved an adapted ideal deformation cross-section, which, in particular, leads to an optimal result in welding with the connecting part.

Advantageously, it can be achieved with the here presented aspect of the invention that the deformation cross-section can be adjusted so that a different material characteristic can be compensated between the first and second film and/or an asymmetrical design of a connecting part can be compensated by a different deformation cross-section and an optimized welding result can achieve in the area of the connecting part.

It should be expressly understood, that the subject matter of the third aspect can be advantageously combined with the subject matter of the above aspects of the invention, and well as individually or in any combination cumulatively.

According to a fourth aspect of the invention, the object is solved by a method of manufacturing bags for use for medical purposes using a device according to the first aspect of the invention, for reducing a cross-necking of the bag in a filled state.

Conceptually, the following is explained:

The term “cross-necking” of the filled bag is understood as the adjusting constriction of the lateral bag edges when filling the bag. The bag is limited mostly from an upper weld seam, a right weld seam, a left weld seam and a lower weld seam, which weld the first film and the second film circumferentially together to form a bag. In particular, the upper weld has a connecting part for filling and emptying the bag. When filling the bag, a medium reaches, in particular through the connector part, into the bag, which requires a volume, wherein this volume is provided by the bag. For this purpose, the into the bag penetrating medium displaces the first and the second film between the surrounding weld seams, so that the distance increases between the first and second foils within the peripheral weld seams. An increasing of the distance between the first and second film requires for reasons of the continuity of material that the bordering edges of the bag are simultaneously pulled inside.

The geometry of the surrounding weld seams requires that the corners have a more rigid characteristic with respect to the, by the filling of the bag created, pull of the films compared to the edges of the bag. Because of this more rigid material characteristic of the bag corners it leads to a constriction of the lateral bag edges compared with the corners of the bag. A concomitant of this constriction are often resulting wrinkles in the first and the second film, which extends from the bag corners toward the centre of the bag.

The prior art has heretofore provided that a flat first film and a flat second flat foil of rectangular or squared surrounding welds are welded into a bag. A deformation of the mostly flat first film and the mostly flat film is only known in the in the state of the art in the range of the connecting part, wherein said deformation range should counteract effects associated with the connecting part. So it comes in the prior art to a constriction of the bag edges when filling the bag.

By way of derogation, it is proposed here that the deformation region is further extended from the area of the connecting part and thereby also areas of the first and second film are deformed, that are placed more at the centre of the already welded bag, causing a crosswise constriction of the bag is prevented or at least reduced in the filled state.

Advantageously, it can be achieved here by the presented aspect of the invention that the bag constricts less when deforming. In particular, it can be achieved that the bag has less narrowing. Doing so, internal stresses due to filling the bag can be prevented or at least reduced, whereby the loads acting on the material of the filled bag can be reduced.

In particular, it can also be achieved that stresses on the weld seams can be reduced so that the width of the weld seams can be reduced by the aspect of the invention presented here. As a result, more aesthetic bags can be made, which also require less material, whereby it can be achieved also due to the reduction of the loads in the film of the bag that the film thickness of the bag can be reduced.

It should be expressly understood that the subject matter of the fourth aspect can be advantageously combined with the subject matter of the above aspects of the invention, and as well as individually or in any combination cumulatively.

According to a fifth aspect of the invention, the object is solved by a plant for producing bags of two foils with one, an axial direction having, between the foils welded connecting part, wherein the plant is a device, i.e. machine or station, according to the first aspect of the invention and/or a method according to the second aspect of the invention and/or a manufacturing method according to the third aspect or the fourth aspect of the invention.

Conceptually, the following is explained:

A bag is a hollow, thin-walled, easily deformable object that is suitable for the reception of other objects, in particular suitable for the reception of liquids. In particular, it can be filled and emptied.

It is understood that the advantages are applied on a device for extending a film and for welding the foil to an axial direction having connecting part, with an extension device for extending the film inside and/or outside a connection region of the film, wherein the extension device comprises a deformation tool, wherein the deformation tool comprises an in an extension direction of the deformation tool running out deformation cross-section of the deformation tool, and/or has the advantages of a method of welding a connection region of a film with an axial direction having connection part with a device according to the first aspect of the invention, wherein the film is first extended and then the connection region is welded to a an axial direction having connecting part, and/or has the advantages of a bag making method for use for medical purposes by welding two foils in one axial direction having connecting part to a bag according to a third aspect of the invention, as described above immediately on a plant for producing bags of two foils with one between the foils welded an axial direction having connecting part, wherein the plant has just this device.

It should be expressly understood that the subject matter of the fifth aspect can be advantageously combined with the subject matter of the above aspects of the invention, and as well as individually or in any combination cumulatively.

According to a sixth aspect of the invention, the object is solved by a bag made of two films and a an axial direction having connecting part by means of a device according to the first aspect of the invention and/or a method according to the second aspect of the invention and/or a manufacturing method according to the third aspect or the fourth of invention and/or with a system according to the fifth aspect of the invention.

It is understood that the advantages are applied on a device according to the first aspect of the invention and/or a method according to the second aspect of the invention and/or a manufacturing method according to the third aspect of the invention and/or a plant according to the fourth aspect of the invention, as described above, directly on a bag made of two films and on a an axial direction having connecting part by means of a device according to the first aspect of the invention and/or a method according to the second aspect of the invention and/or a manufacturing method according to the third aspect of the invention and/or with a plant according to the fourth aspect of the invention.

It should be expressly understood that the subject matter of the sixth aspect can be advantageously combined with the subject matter of the above aspects of the invention, as well as individually or in any combination cumulatively.

Further suggestions regarding the practice of this invention may also be taken from the WO 2010/025699 A1 from the same applicant, which has a comparable background, but disclosed no deformation tool, which comprises in an extension of the deformation tool a region with an in an extension direction running out deformation cross section of the deformation tool. The WO 2010/025699 A1 is in the present patent application by way of reference to be understood as fully disclosed.

The invention will be described below with reference to an exemplary embodiment explained in detail on the drawing. There shows:

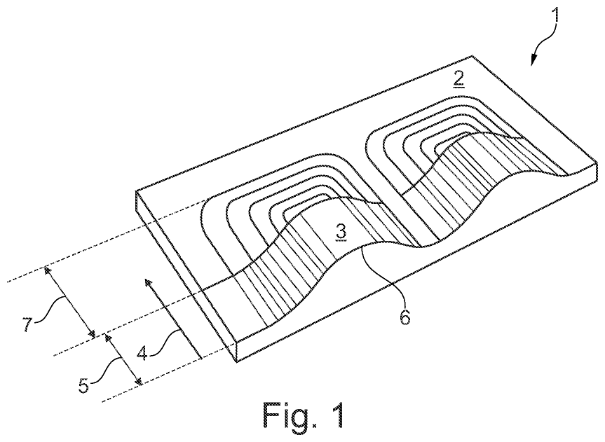

FIG. 1 shows schematically a deformation tool with symmetrical deformation cross-section,

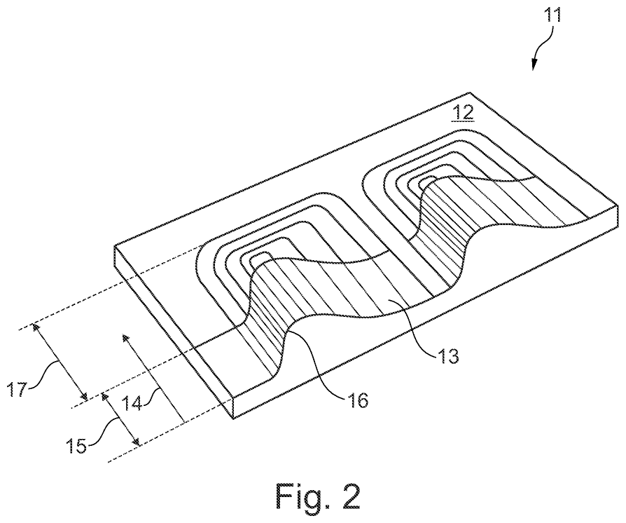

FIG. 2 is a schematic view of a deformation tool with asymmetric deformation cross-section,

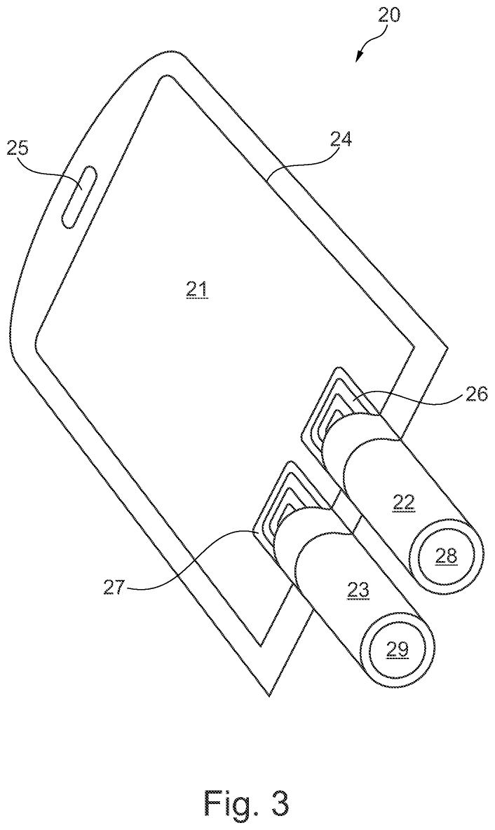

FIG. 3 shows schematically a bag for medical purposes with two connecting parts, and

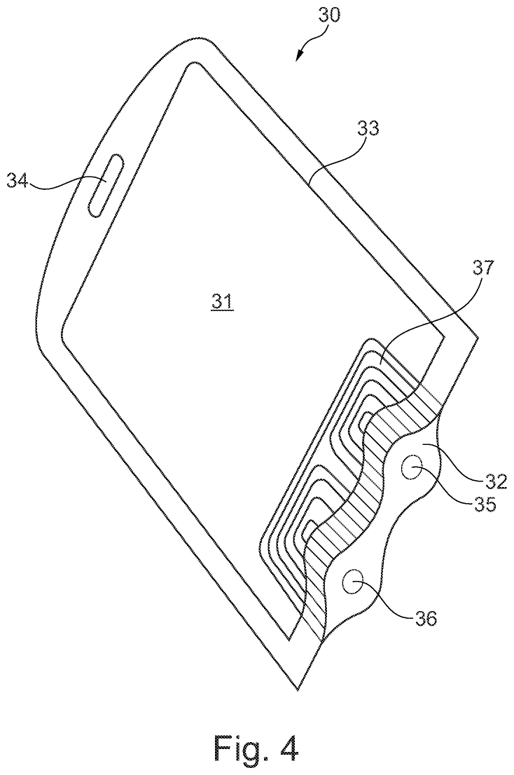

FIG. 4 shows schematically a bag for medical purposes with a connecting part.

The deformation tool 1 in FIG. 1 has a plane 2 and a deformation region 3.

The deformation tool 1 has an extension direction 4 which coincides with the axial direction (not shown) of the later to be welded connection part (not shown).

The deformation tool 1 has a first region 5 with an in extension direction of 4 of the deformation tool 1 constant remaining symmetrical deformation cross-section 6 and a second region 7, in which the deformation cross-section 6 runs out in the plane 2.

The plane 2 can in an advantageous embodiment coincide at the end of the deformation offset (not shown) with the film plane (not shown).

The deformation cross-section 6 of the deformation tool 1 is wave-shaped and sinusoidal.

The deformation tool 11 in FIG. 2 has a plane 12 and a deformation region 13.

The deformation tool 11 has an extension direction 14 that coincides with the axial direction (not shown) of the later to be welded connecting part (not shown).

14 of the deformation tool 11 constant remaining asymmetric deformation cross-section 16 and a second region 17, in which the deformation cross-section 16 runs out in the plane 12.

The plane 12 may coincide in an advantageous embodiment at the end of the deformation offset (not shown) with the film plane (not shown).

The deformation cross-section 16 of the deformation tool 11 is wave-shaped.

The bag 20 in FIG. 3 consists essentially of a reservoir 21, a first connecting part 22 and a second connecting part 23.

The reservoir 21 consists of a first film (not marked), a second film (not marked), the first connecting part 22 and the second connecting part 23.

The reservoir 21 has a surrounding weld line 24, which extends also on both sides over the first connecting part 22 and the second connecting part 23.

The upper end of the bag 20 has a cutout 25 which is used for the purpose to fix the bag 20.

The bag 20 has following the first connecting part 22 and the second connecting part 23, extending to the centre of the bag (not marked), in each case a deformation 26,27 of the first film (not marked) and the second film (not marked) opposite to the bag plane (not marked).

The first connecting part 22 and the second connecting part 23 have a cylindrical shape.

The first connector 22 and the second connector 23, each, have an access point 28, 29, via which the bag 20 can be filled and/or be emptied.

The bag 30 in FIG. 4 consists essentially of a reservoir 31 and a connecting part 32.

The connecting part 32 could be produced, in a particularly preferred embodiment by injection molding.

The reservoir 31 consists of a first film (not marked), a second film (not marked) and the connecting part 32.

The reservoir 31 has a surrounding weld line 33, which also extends on both sides over the connecting part 32.

The upper end of the bag 30 has a cutout 34 which is used to fix the bag 30.

The connecting part 32 has a first access point 35 to the reservoir 31 of the bag 30 and a second access point 36 to the reservoir 31 of the bag 30 via which the bag 30 can be filled and/or be emptied.

The bag 30 has, following the connecting part 32, extending to the bag centre (not marked), a deformation 37, each, of the first film (not marked) and the second film (not marked) opposite the bag plane (not marked).

### LIST OF REFERENCE NUMBERS USED

1 deformation tool
2 plane
3 deformation region
4 extension direction
5 first region
6 deformation cross section
7 second region
11 deformation tool
12 plane
13 deformation region
14 extension direction
15 first region
16 deformation cross-section
17 second region
20 bags
21 reservoir
22 connection piece
23 connecting part
24 welding line
25 cutout
26 deformation
27 deformation
28 access point
29 access point
30 bags
31 reservoir
32 connecting part
33 welding line
34 cutout
35 access point
36 access point
37 deformation

1. A method of manufacturing a medical bag comprising:
providing a deformation tool comprising:
a first region comprised of a deformation region having a wave-shaped cross section; and
a second region, wherein the deformation region tapers into a plane as the deformation region extends from the first region to the second region;
deforming a first connection region of a film with the deformation region of the deformation tool;
deforming a second connection region of the film with the deformation region of the deformation tool;
placing the first connection region on a connecting part;
placing the second connection region on an opposite side of the connecting part;
welding the first connection region and the second connection region to the connecting part in an axial direction of the connecting part; and
welding edges of the film together to seal the medical bag.

2. The method of claim 1, wherein prior to deforming a first connection region of a film with the deformation tool, the method further comprising lengthening the film with an extension device.

3. The method of claim 2, wherein prior to placing the first connection region on a connecting part, the method further comprising cooling the first connection region and the second connection region of the film.

4. The method of claim 1, wherein the deformation region is symmetric.

5. The method of claim 1, wherein the deformation region is asymmetric.

6. The method of claim 1, wherein the film is comprised of a first film including the first connection region and a second film including the second connection region.

7. A method of manufacturing a medical bag comprising:
providing a deformation tool comprising:
a first deformation region having a first cross section; and
a second deformation region on an opposite side of the deformation tool as the first deformation region, the second deformation region having a second cross section that differs from the first cross section;
deforming a first connection region of a film with the first deformation region of the deformation tool;
deforming a second connection region of the film with the second deformation region of the deformation tool;
placing the first connection region on a connecting part;
placing the second connection region on an opposite side of the connecting part;
welding the first connection region and the second connection region to the connecting part in an axial direction of the connecting part; and
welding edges of the film together to seal the medical bag.

8. The method of claim 7, wherein prior to deforming a first connection region of a film with the deformation tool, the method further comprising lengthening the film with an extension device.

9. The method of claim 8, wherein prior to placing the first connection region on a connecting part, the method further comprising cooling the first connection region and the second connection region of the film.

10. The method of claim 7, wherein the first deformation region is symmetric.

11. The method of claim 7, wherein the first deformation region is asymmetric.

12. The method of claim 7, wherein the film is comprised of a first film including the first connection region and a second film including the second connection region.
